(19) United States
(12) Patent Application Publication
(10) Pub. No.: US 2023/0250300 A1
(43) Pub. Date: Aug. 10, 2023

(54) DURABLE ANTIMICROBIAL COATING AND PREPARATION THEREOF

(71) Applicant: Resysten International Ltd., London (GB)

(72) Inventors: János Pintér, Törökbálint (HU); Péter Lehoczky, Biatorbágy (HU); László Janovák, Szeged (HU); Imre Dékány, Szeged (HU)

(21) Appl. No.: 17/665,528

(22) Filed: Feb. 5, 2022

(51) Int. Cl. C09D 5/14; C09D 7/20; C09D 133/12; B01J 35/00; B01J 37/02; B01J 21/06; B01J 23/06

(52) U.S. Cl. CPC C09D 5/14; C09D 7/20; C09D 133/12; B01J 35/004; B01J 37/0221; B01J 21/063; B01J 23/06; B01J 35/0013; B01J 35/006

(57) ABSTRACT

A process for the preparation of kinetically stable semiconductor/polymer nanodispersion whereby the aqueous stability of the dispersed photocatalysts and polymer latex particles are ensured by the high surface charge. Consequently, the thin photocatalytically active antimicrobial coating prepared from this electrostatically stabilized aqueous dispersion by spray-coating method contains well-dispersed and evenly distributed surface photocatalyst particles immobilized by polymer and thus it provides homogeneous, transparent and mechanically stable photoreactive and antimicrobial thin film on arbitrary surfaces.

### I. BACKGROUND

### A. Field of Invention

The present invention generally relates to durable antimicrobial coatings and preparations thereof. In particular, the invention teaches a stabilized nanodispersion used for the preparation of durable and wear resistant transparent antimicrobial coating and preparation method thereof.

### B. Description of the Related Art

Repulsive electrostatic double-layer forces are responsible for the stabilization of charged colloidal particles in the presence of adsorbed polyelectrolytes of opposite and high line charge densities. Stability of metal nanoparticles (NPs) in suspensions depends on several factors, e.g pH, ionic strength or particle surface chemistry. The effect of the pH strongly influences the zeta potential of the NPs, i.e. it affects the stability of the suspension. Determining the zeta potential is a key factor in the study of colloidal stability.

The surface charge of the particles can be described by the value of the zeta potential. The point of zero charge (PZC) is the value where the zeta potential is close to zero and the particles agglomerate easily. If the zeta potential is a high value (positive or negative) the stability of the dispersion is increased, due to the electrostatic repulsion of the particles.

In aqueous dispersion metal oxides (e.g. TiO2 or ZnO) hydrolyse and hydroxide layers are formed on the surface. Change in the pH of the solution can result in the protonation or deprotonation of the surface groups and this process can increase or decrease the particles charge. In a complex dispersion where more than one nanoparticle or e.g polymers are present, they can interact with each other, which can cause agglomeration and sedimentation. Titanium-dioxide is charged strongly positive under pH 6, and strongly negative above pH 7. The PZC value of TiO2, where the charge of the particles is close to zero is reached around 6.2±0.1. This shows that the surface charge depends on the pH value. In the case of zinc-oxide the surface charge is positive under pH=9.4, due to the Zn2+(aq) and Zn(OH)+(aq) ions present. Above pH 10 charge inversion occurs as the Zn(OH)2(s), Zn(OH)3−(aq) and Zn(OH)42−(aq) become dominant in the system, and the surface charge changes to negative. The PZC value of ZnO is found to be at pH 9.4.

The term photocatalyst is a combination of two words: photo related to photon and catalyst, which is a substance altering the reaction rate in its presence. Therefore, photocatalysts are materials that change the rate of a chemical reaction on exposure to light. This phenomenon is known as photocatalysis. Photocatalysis includes reactions that take place by utilizing light and a semiconductor. The substrate that absorbs light and acts as a catalyst for chemical reactions is known as a photocatalyst. All the photocatalysts are basically semiconductors. Photocatalysis is a phenomenon, in which an electron-hole pair is generated on exposure of a semiconducting material to light. The photocatalytic reactions can be categorized into two types on the basis of appearance of the physical state of reactants: (i) Homogeneous photocatalysis: When both the semiconductor and reactant are in the same phase, i.e. gas, solid, or liquid, such photocatalytic reactions are termed as homogeneous photocatalysis. (ii) Heterogeneous photocatalysis: When both the semiconductor and reactant are in different phases, such photocatalytic reactions are classified as heterogeneous photocatalysis. The energy difference between the valence band (HOMO) and the conduction band (LUMO) are known as the band gap (Eg). On the basis of band gap, the materials are classified into three basic categories: (1) metal or conductor: Eg<1.0 eV; (2) semiconductor: Eg<1.5-3.0 eV, (3) insulator: Eg>5.0 eV.

Semiconductors are capable of conducting electricity even at room temperature in the presence of light and hence, work as photocatalysts. When a photocatalyst is exposed to light of the desired wavelength (sufficient energy), the energy of photons is absorbed by an electron (e−) of valence band and it is excited to conduction band. In this process a hole (h+) is created in valence band. This process leads to the formation of photo-excitation state, and e− and h+ pair is generated. This excited electron is used for reducing an acceptor in which a hole is used for oxidation of donor molecules. The importance of photocatalysis lies in the fact that a photocatalyst provides both oxidation as well as a reduction environment and that too, simultaneously. The fate of the excited electron and hole is decided by the relative positions of the conduction and valence bands of the semiconductor and the redox levels of substrate.

There are four ways in which the semiconductor and the substrate interact with each other depending upon the relative positions of the valence and conduction bands and the redox levels. The four different combinations are: (1.) Reduction of substrate takes place, when the redox level of substrate is lower than the conduction band of the semiconductor. (2.) Oxidation of substrate takes place, when the redox level of the substrate is higher than the valence band of the semiconductor. (3.) Neither oxidation nor reduction is possible, when the redox level of the substrate is higher than the conduction band and lower than the valence band of the semiconductor. (4.) Both reduction and oxidation of the substrate take place, when the redox level of the substrate is lower than the conduction band and higher than the valence band.

Photocatalysts may be used for antifouling, antifogging, conservation and storage of energy, deodorization, sterilization, self-cleaning, air purification, wastewater treatment, etc. Semicoductors act as sensitizers for photoredox processes due to their electronic structure. Some semiconductors are able to photocatalyze the complete mineralization of many organic pollutants like aromatics, halo hydrocarbons, insecticides, pesticides, dyes, and surfactants.

Metal oxides have a wide range of application to solve environmental problems and in electronics due to their capacity to form charge carriers when they are exposed to light. Metal oxides have properties like: required electronic structure, light absorption properties, charge transport characteristics, Semiconductor-mediated photocatalysis has gained huge attention as it helps to overcome the problem related to fast charge recombination.

Binary oxides photocatalyst can be categorized into three categories: 1. titanium dioxide, 2. zinc oxide, and 3. other metal oxides like molybdenum oxide, vanadium oxide, indium oxide, tungsten oxide, and cerium oxide.

Titanium dioxide is a promising material for photocatalytic applications due to its availability, low cost, and non-toxic nature. However, due to its wide band gap (Eg=3.2 eV for anatase), and fast recombination rate of photogenerated electron and hole pairs, it needs high-energy (UV) photons to be activated and has a low quantum efficiency.

ZnO nanostructures have been shown to be prominent photocatalyst candidates to be used in photodegradation owing to the facts that they are low-cost, non-toxic and more efficient in the absorption across a large fraction of the solar spectrum compared to TiO2. Comparable to TiO2, ZnO is an n-type semiconductor oxide but has not been well investigated in previous studies. ZnO has been proposed as an alternative photocatalyst to TiO2 as it possess same band gap energy but exhibits higher absorption efficiency across a large fraction of the solar spectrum when compared to TiO2.

During the illumination of the most commonly applied heterogenous photocatalyst particles, reactive oxygen species with high oxidative potential are formed. These species include superoxide radicals (O2−), hydroxyl radicals (HO·) and hydrogen peroxide (H2O2): with the help of these, the photocatalyst-containing surfaces can oxidize organic pollutants and eliminate microorganisms.

During practical applications, it is of crucial importance to provide proper adhesion between the photocatalyst particles and everyday substrate materials, such as glass, textile, paper, ceramics or wall and plastic surfaces. Polymer-based coatings are the state-of-the-art composites of this field, having the highest versatility. Polymers are esteemed photocatalyst binders as they have adjustable elasticity, low density, price and excellent impact-resistance.

### II. SUMMARY

The foregoing invention teaches a process for the preparation of kinetically stable semiconductor/polymer nanodispersion whereby the aqueous stability of the dispersed negatively charged photocatalyst particles and anionic polyelectrolyte latex particles are ensured by the high surface charge. These identical negative surface charge caused electrostatic repulsive forces between the dispersed particles are induced by adjusting the pH. These repulsive forces keep the particles in well-dispersed form in the aqueous medium Consequently, the thin photocatalytically active antimicrobial coating prepared from this electrostatically stabilized homogeneous aqueous dispersion by spray-coating method contains well-dispersed and evenly distributed surface photocatalyst particles in polymer binder layer and thus it provides homogeneous, transparent and mechanically stable photoreactive and antimicrobial thin film on arbitrary surfaces. Moreover, the homogeneous surface distribution of the non-aggregated photocatalyst particles ensures that the light induced photocatalytic process effectively takes place and enough reactive oxygen species (ROS) generate to exert their photooxidation ability.

### III. BRIEF DESCRIPTION OF THE DRAWINGS

The invention may take physical form in certain parts and arrangement of parts, some embodiments of which will be described in the specification and illustrated in accompanying drawings which form a part hereof, wherein, when referring to the drawings, the inventor identifies the following components thereto,

FIG. 1 provides TiO2 (0.016%)/ZnO (0.004%)/and anionic polyacrylate (0.08%) containing aqueous dispersion at different pH values;

FIG. 2 is a graph showing zeta potential values of 0.01% aqueous TiO2 dispersion as a function of pH;

FIG. 3A are examples of TEM aggregated Degussa P25 TiO2 photocatalyst particles at pH=6;

FIG. 3B are examples of TEM aggregated Degussa P25 TiO2 particles at pH=9;

FIG. 4 is a graph showing the zeta potential values of 0.01% aqueous ZnO dispersion as a function of pH;

FIG. 5 is a graph showing the zeta potential values of 0.01% aqueous polymer latex particle dispersion as a function of pH;

FIG. 6 shows the chemical structure of poly(methyl methacrylate-co-methacrylic acid) polymer binder material and the TEM picture of the polymer latex particles;

FIG. 7 is a graph showing the effect of pH on the particle size of 0.01% aqueous TiO₂ dispersion (determined by DLS method);

FIG. 8 is a graph showing the effect of pH on the particle size of 0.01% aqueous ZnO dispersion (determined by DLS method);

FIG. 9 is a graph showing the zeta potential values of 0.01% aqueous poly(methyl methacrylate-co-methacrylic acid) polymer latex dispersion as a function of pH;

FIG. 10 shows the effect pH of aqueous dispersion on the film structure and homogeneity of photoreactive composite thin film;

FIG. 11 is a schematic representation of the photoreactive composite coating prepared by spray-coating method from aqueous dispersion;

FIG. 12 is a schematic representation of the photocatalytic degradation of ethanol vapour (c0=0.35 mM) on pure TiO2 photocatalyst film and polymer containing composite layer (TiO2/polymer ratio=60/40 wt. %);

FIG. 13 is a graph showing the effect of light intensity on the surface ROS concentration produced under irradiance of the photoreactive layer. The inserted figure shows the distance dependence of light intensity (here the dashed line is guide to eyes);

FIG. 14 is a graph showing the measured weight loss values as a function of abrasion cycle applied on photoreactive layers with and without polymer binder;

FIG. 15 are examples of photoreactive layers before and after of the abrasive test;

FIG. 16 are examples of before and after wiping photoreactive coating created on glass plate;

FIG. 17 are examples of SEM and EDX for carbon and titania content of the initial and wiped photoreactive surface (60 wt % TiO2/40% polymer); and,

FIG. 18 is a schematic representation of antibacterial efficiency of photoreactive coating measured by ISO 27447:2009 standard against E. coli test bacteria under visible light illumination with statistical analysis: *p<0.05 vs. blank.

### IV. DETAILED DESCRIPTION OF THE INVENTION

As mentioned before, stability of semiconductor nanoparticles in aqueous media depends on several factors, e.g. pH, ionic strength or particle surface chemistry. Thus, the effect of the pH strongly influences the zeta potential of the particles, which is also affects the stability of the suspension.

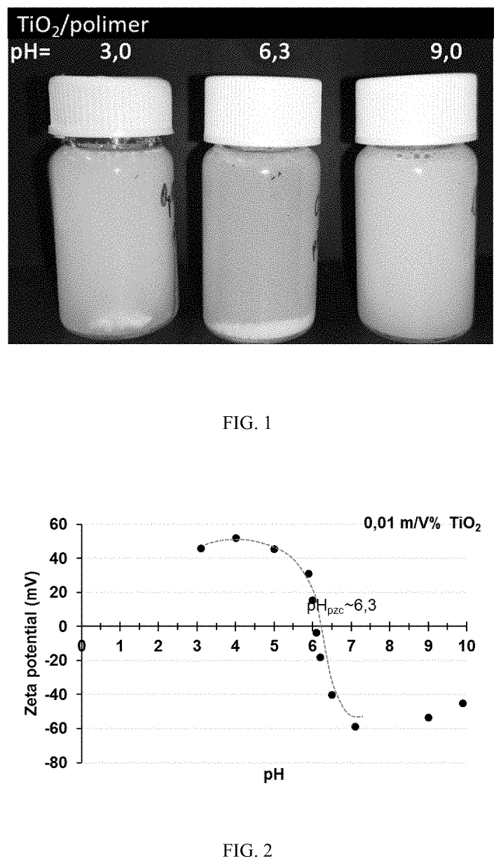

FIG. 1 represents the photos of the TiO2 (0.016%)/ZnO (0.004%)/and anionic polyacrylate (0.08%) containing aqueous dispersion at different pH values. The difference is conspicuous: while at acidic (=3.0) or closely neutral pH (=6.3) the suspensions show unstable condition with clearly visible white sediment, at alkaline pH (=9.0) homogeneous sample was obtained. The reason for this is can be found in the colloidal stability of the dispersion. Repulsive electrostatic double-layer forces are responsible for the stabilization of charged colloidal particles. Stability of nanoparticles (NPs) in suspensions depends on several factors, e.g. pH, ionic strength or particle surface chemistry (F. M. Omar et al., 2014). The effect of the pH strongly influences the zeta potential of the NPs, i.e. it affects the stability of the suspension. Thus, determining the zeta potential is a key factor in the study of colloidal stability.

The particle size and zeta potential values of the synthetized latex nanoparticles and photocatalyst particles (0.01% aqueous dispersion) were determined by dynamic light scattering (DLS) at different pH1 values with a Zetasizer Nano ZS ZEN 4003 apparatus (Malvem Ins., UK) equipped with a He—Ne laser (λ=633 nm). The measurements were performed at 25±0.1° C. Size distribution measurements by DLS were carried out in triplicate, and average values are reported. Error bars refer to the standard deviation. FIG. 2 shows the zeta potential values of 0.01% aqueous TiO₂ dispersion as a function of pH. When pH<5, TiO₂ surface charge is found strongly positive and exhibit a constant ζ potential value equal to +50.0±3.1 mV. By increasing the pH, the point of zero charge (PZC) is reached with a value found here equal to 6.3±0.1. By further increasing the pH, TiO2 NPs exhibit a negative surface charge which stabilizes at a y potential value of −50.0±10.6 mV for a pH ranging from 7 to 10. Thus, it has been discovered that when pH<5 and pH>8, the TiO₂ NPs are found stabilized against aggregation.

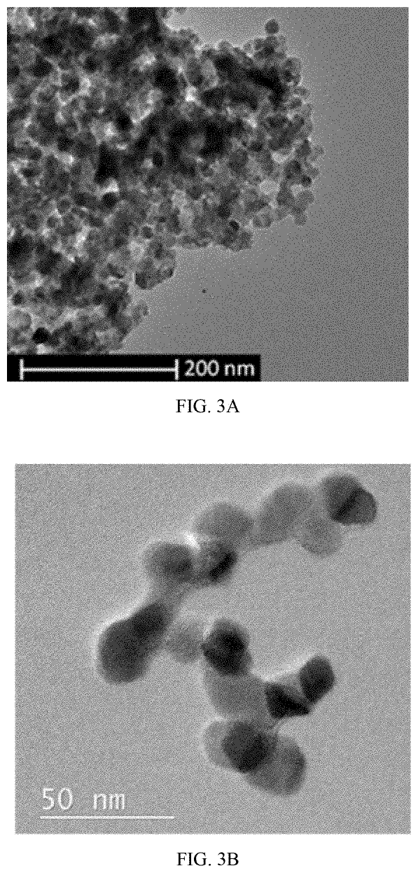

To study the morphology and aggregation state of the photocatalyst nanoparticles, transmission electron microscopy (TEM) measurements were performed using a FEI Tecnai G2 20 X-TWIN microscope with a tungsten cathode operated at 200 kV. For TEM measurements, 10 μL of aqueous nanodispersion was dropped on a grid (carbon film with 200 Mesh coper grids (CF200-Cu, Electron Microscopy Sciences, USA) and dried at room temperature. The above presented results were also supported by the results shown in FIG. 3. TEM show that at pH=6 highly aggregated TiO₂ particles were obtained while at pH=9 separated, 10-20 nm Degussa P25 TiO2 particles can be observed.

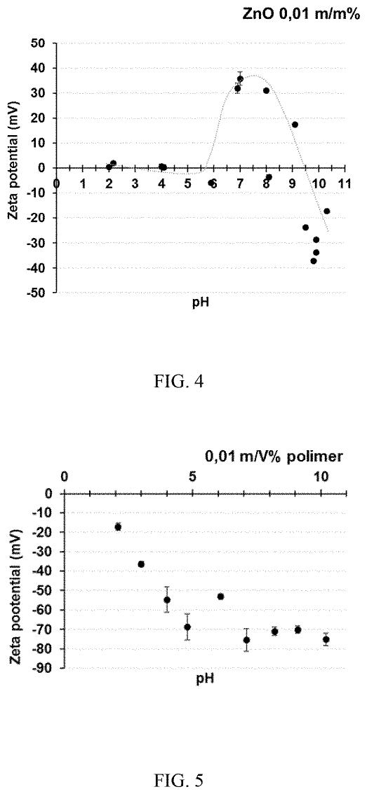

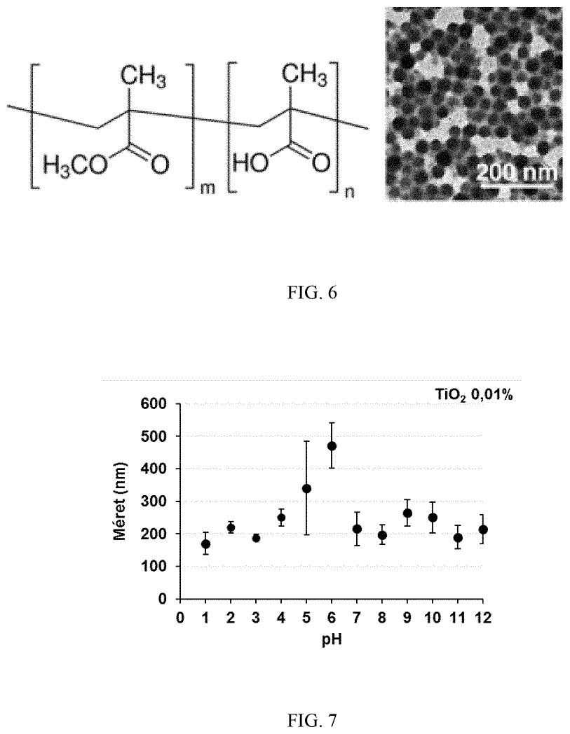

Similarly. the corresponding zeta-potential values of ZnO (FIG. 4) and aqueous poly(methyl methacrylate-co-methacrylic acid) polymer latex particle dispersion (FIG. 5) were also determined as a function of pH. In the case of ZnO (FIG. 4) the pH of zero point charge (PZC) of ZnO nanoparticles was 9.5±0.6, it was discovered that for pH values lower than 10.1 the surface of the ZnO nanoparticles was positively charged while above this pH negatively charged. As regarding the polymer latex particles (FIG. 5) it can be seen that until around pH=5-6 the measured zeta potential values were continuously decreased and reached the ca. −75 mV value. This is due to the deprotonation of methacrylic acid functional groups of polymer as a function of pH (FIG. 6).

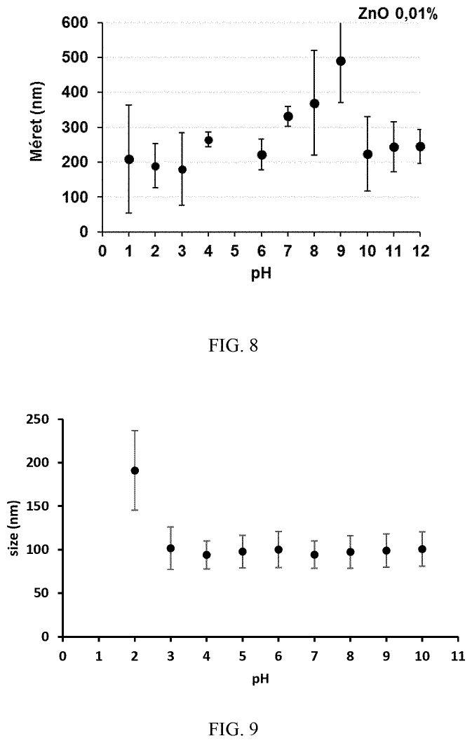

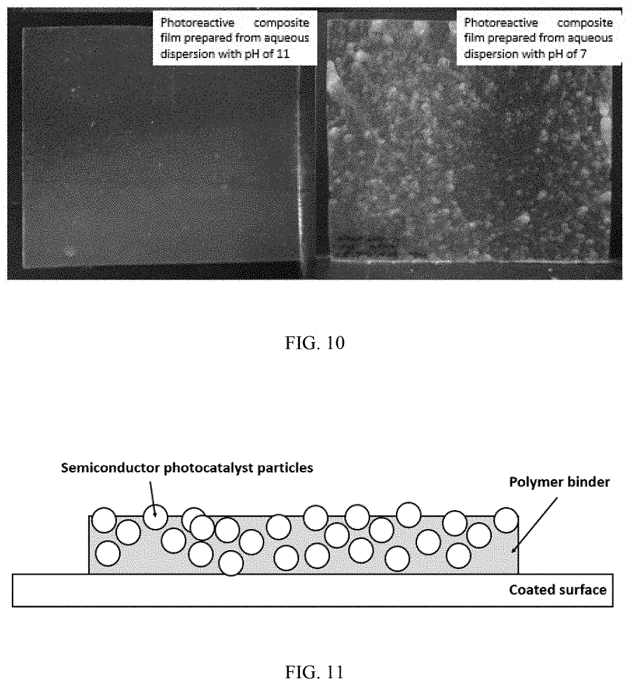

The above presented surface charge and colloidal stability was also affected the particle size of the semiconductor photocatalysts and polymer dispersion. FIGS. 7 and 8. show the particle size of TiO₂ and ZnO. In both cases the highest values were measured at pH=PZC, since at this point the particle size of both TiO2 and ZnO was almost 500 nm at pHP=˜6) and ˜9, respectively. This is obviously due to the pH induced neutral charge of the particles. However, it also can be seen that at alkaline pH (>9-10) the measured size values were significantly decreased until about 200 nm indicating the disaggregation of the particles. Moreover, at this pH the polymer latex particles were also shown negatively charged surface (FIG. 5) with a particle size of ˜100 nm (FIG. 9). The foregoing confirms that by the proper adjustment of the pH (>9) the stability of the aqueous dispersion can be significantly improved trough the electrostatic repulsion of the dispersed particles. This also manifested in the film properties prepared from the aqueous dispersions with different pH: if the pH was neutral (pH=7), a very inhomogeneous, stained thin film was obtained, while at alkaline pH the film was homogenous and smooth (FIG. 10).

FIG. 11. shows the schematic drawing of the photoreactive composite coating prepared by spray coating method and it consists of two main components: the semiconductor photocatalyst particles responsible for the light induced photocatalytic effect while the role of the polymer binder is the immobilization of the particles on the surfaces. The chemical structure of the polymer can be seen on FIG. 6. It was synthesized by soapless emulsion polymerizations from methyl methacrylate and methacrylic acid monomers. Due to the emulsion polymerization polymeric nanoparticles were obtained. The thin films can be prepared by spray coating method, however, it was found that the pH of the aqueous suspension is highly affected both the stability of the suspension (FIG. 1) and the homogeneity of the thin films obtained (FIG. 10).

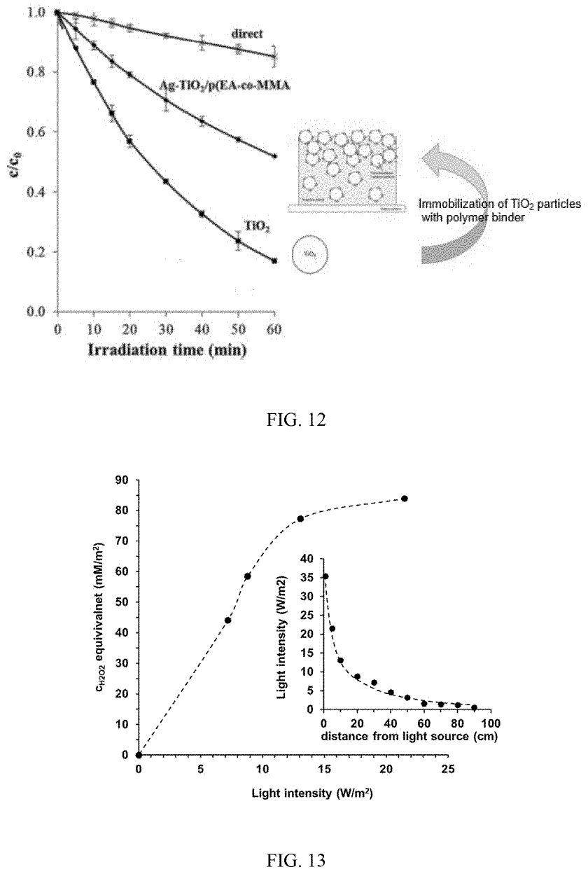

The next important issue is how the presence of polymer in the composite layer affects the photocatalytic properties of the TiO₂ and ZnO particles. FIG. 12 represents the photocatalytic degradation of ethanol vapour (c₀=0.36 mM) on pure TiO₂ photocatalyst film and polymer containing composite layer (TiO₂/polymer ratio=60/40 wt. %). The composition of ethanol vapor was analyzed by gas chromato-graph (Shimadzu GC-14B) equipped with a thermal conductivity (TCD) and a flame ionization detector (FID). The flow rate of the gas mixture in the photoreactor system was 375 mL×min⁻¹. The initial concentration of the ethanol was 0.36±0.018 mmol L⁻¹ atrelative humidity of ˜70%. The light source (LightTech light source, Hungary) was fixed at 50 mm distance from the films. After injection of ethanol and water vapour, the system was left to stand 30 min for the establishment of adsorption equilibrium on the surface of films. During the measurements, the c/c0 values were determined as a function of illumination time, where c is the concentration of ethanol at time (t) and co is the initial concentration (c0=0.36±0.018 mmol L). In the case of pure TiO₂ without polymer binder, 80% of the initial ethanol was photodegraded under 60 min illumination time.

Incorporation of the photocatalysts particles into the polymer matrix resulted in a ˜50% decrease in the photocatalytic reaction rates, compared to pure TiO₂, since the polymer partially covered the photocatalyst particles. Next it was also studied how many radicals are formed on the photoreactive surface depending on the light intensity since considering the potential antimicrobial application of the photoreactive coating, it is also an important question.

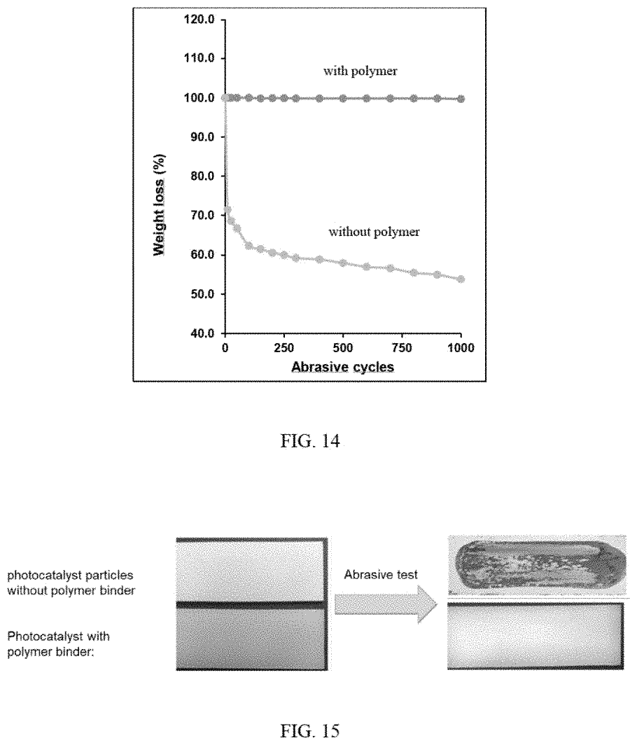

The amount of hydroxyl radicals was measured from the reaction of luminol and hydrogen peroxide. The results were calculated from the chemiluminescence (CL) data with Sirius L Single Tube luminometer (Berthold Detection Systems, Hungary). Six milligrams of luminol was diluted in 1 mL of sodium hydroxide (0.1 M) and filled out to 20 mL with distilled water. The nanohybrid films were immersed in 40 mL of distilled water, then illuminated and shaken continuously during the experiment using a magnetic stirrer. Samples were taken after 60 min of illumination, 100 μL of the samples was added to 100 μL of luminol solution, and the intensity of the chemiluminescence was measured immediately with the luminometer (Hirakawa, T., and Nosaka, Y. (2002). Properties of O2-And OH Formed in TiO2 Aqueous Suspensions by Photocatalytic Reaction and the Influence of H2O2 and Some Ions. Langmuir 18, 3247-3254. doi:10.1021/la015685a). Based on the previously determined calibration curve (0-5 mM), the concentration of OH radicals is directly proportional to the measured RLU values as follows: CH₂O₂ (mM)=measured RLU value/41866, R²=0.9977. For quantitative characterization of the free radical concentration from the RLU data, the calculated equivalent concentration of H₂O₂ (mM) is displayed as a function of illumination time with the used light source (15 W low pressure mercury lamp (LightTech, Hungary) with characteristic emission wavelength at λₘₐₓ=435 nm) at 25.0±0.5° C. The distance of the light source from the nanohybrid films was systematically changed in order to determine how the surface reactive oxygen species concentration changes with increasing distance from the light source. As it can be seen the measured light intensity is inversely proportional to the square of the distance from the source (FIG. 13 inserted graph). In parallel, the reactive oxygen species (ROS) concentration values were also measured at given distances via luminometric measurements. FIG. 13 also shows that the measured ROS concentration values (expressed as H₂O₂ equivalent) increases almost linearly up to ˜13 W/m² light intensity, then a constant value (˜80 mM/m² H₂O₂ equivalent) is taken. For comparison, the average solar irradiance value is about 1000 W/m², however, —according to our measurement—the light intensity values experienced in indoor environment are also sufficient for the generation of reactive species on the photocatalytic coating material. Thus, it can be concluded that the application of polymer matrix was reduced the photocatalytic activity of the embedded TiO₂ particles, however, even at relatively low light intensities, a sufficient amount of radicals is formed on the irradiated photoreactive surface. Furthermore, the mechanical stability and wear resistance of the composite layer was also significantly improved due to the presence of the polymer binder (FIGS. 14-15). To evaluate the abrasion resistance of coatings the taber abraser test is used. The abrasion tests were carried out with a 418 type manual Taber Abraser (United States). During the measurement the pure TiO₂ and TiO₂/polyacrylate (=60:40 wt %) photocatalyt layer with 1 mg/cm² specific surface mass was abraded and the percentage weight loss of the tested surfaces were measured as a function of abrasion cycle.

FIGS. 14 and 15 shows the photos and the measured weight loss values as a function of abrasion cycle applied on photoreactive layers with and without polymer binder. The vulnerability of the pure TiO₂ layer is clearly visible on the photo since after the abrasion test the layer was completely destroyed. According to the percentage weight-loss measurement the layer mass was decreased very sharply, especially during the first few abrasion cycles. On contrast, if we applied polymer for the facilitation of photocatalyst particles immobilization, the mass loss of the composite film was negligible and the TiO₂ particles (and the polymer) were completely covered the surface even after 1000 abrasion cycles. Thus, it can be conclude that the photoreactive layer presented here shows not only obvious photocatalytic properties but its mechanical durability also enables the potential practical use of the coating.

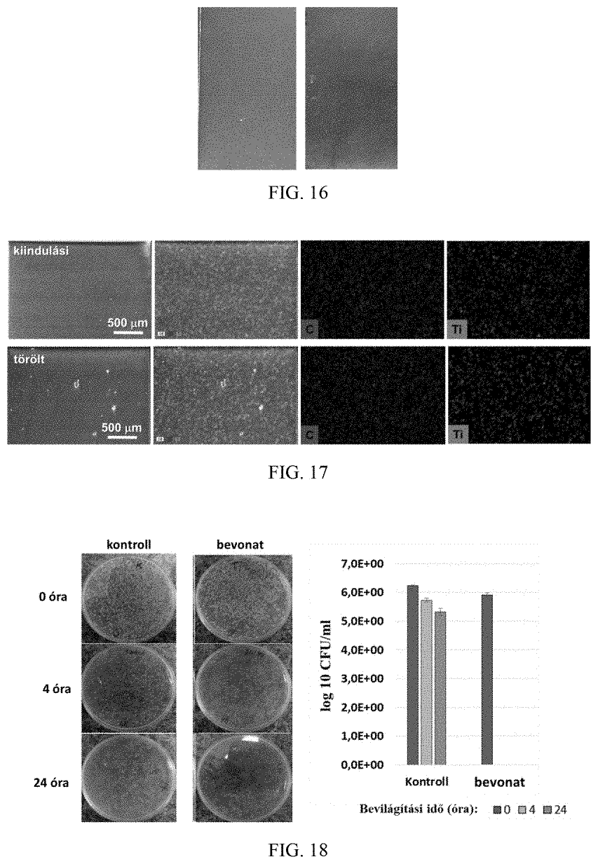

In order to mimic the effect of practical use and the wear resistance of the photoreactive coating the composite layer was also prepare on the surface of glass plate and the coating was wiped with a cloth (FIG. 16.). After this process the surface of the polymer based composite layer was examined by scanning electron microscope (SEM, Hitachi S-4700 microscope), applying a secondary electron detector and 5 kV acceleration voltage. Energy dispersive X-ray spectra were also measured using the Röntec EDX detector at 20 keV. The results on FIG. 17 shows that at this photocatalyst content (60 wt.) in the layer both the C of the polymer (red colour) and the Ti content of the photocatalyst (green colour) expressed on the surface. This dual presence of the components at optimal composition resulted surfaces with simultaneous photocatalytic and good mechanical properties. It can be also seen that after the abrasion (wiping) the photoreactive composite layer exhibited evenly and continuous distribution of the photocatalyst particles and the polymer indicating the wear-resistance behavior.

The antibacterial tests were carried out according to EN ISO 27447:2009 standard. For the evaluation of the surviving bacteria the washing technique was used, because the counting of the survival bacteria is more accurate with this method. Before the microbiological measurements nanohybrid films on glass samples were activated by UV-irradiation for an hour (lightsource: LightTech GCL307T5U/Cell lamp λ=250 nm) to increase the surface concentration of the photocatalyst particles in the surface region of the nanohybrid films. 1×10⁵-5×10⁵ cfu/mL bacterial suspensions were spread uniformly (0.1 mL) on the surface of the nanohybrid films (2.5×2.5 cm²) and covered with the top of Petri dish during the experiment, to avoid water vapour evaporation which can modify results. During the microbiological measurements the glass samples with the nanohybrid films were illuminated with visible-light (light source: LED lamp 7W; λ=405 nm), exposure times were 0, 4 and 24 h. During the experiments the distance of the light source from the nanohybrid films was 35 cm. The light intensity on the surface of the nanohybrid films was measured with a power meter (Thorlabs GmbH, Germany). After different illumination periods the inoculated nanohybrid films were placed into anew sterile Petri-dish by sterile tweezers and the inoculums were washed out from the activated nanohybrid films with 3 mL sterile physiological saline water to regain all surviving bacteria from the uneven surface of the samples. Bacterial suspensions with survival bacteria were streaked (0.1 mL) uniformly on the Mueller-Hinton (Oxoid, Hampshire, UK) media. After the incubation time (37° C.; 24 h) the antibacterial activity was evaluated by counting colony forming units (cfu/mL) with BZG40Colony Counter (WTWGmbH, Germany). The number of colony forming units were converted to the cell number of the survival bacteria per milliliter of the original inoculums on the nanohybrid films. The result on FIG. 18. represent that the photoreactive coating have obvious antibacterial effect: after 4 and 24 h irradiation time 100% of the initial 5×10⁵ cfu/ml E coli bacteria were inactivated on the surface of composite layer.

### EXAMPLES

### Example 1: Synthesis of poly(methyl methacrylate-co-methacrylic acid) Latex Particles

The poly(MMA-MAA) latex particles (FIG. 6.) were synthesized by soapless emulsion polymerizations. In this reaction, MMA (16.5 g) and MAA (5.5 g) were polymerized in the presence of H₂O (180 g) using 0.1 wt. % potassium persulfate (KPS) as heat-initiator. The polymerization was carried out at 80° C. for 2 h under a nitrogen atmosphere and continuous agitation (˜600 rpm). After the reaction proceeded for 2 h, 20-40 nm poly(MMA-MAA) latex particles (FIG. 6.) were obtained and the conversion of monomers, which was measured by the method of weight analysis, was about 98.6%. Then the poly(MMA-MAA) latex particles were purified by centrifugation and washed with deionized water. After the purification process, poly(MMA-MAA) latex particles were redispersed in deionized water in a concentration of 30%.

### Example 2: Synthesis of Photoreactive Coating Material Consists of TiO₂, ZnO and Anionic Polyacrylate Binder

During the synthesis of the aqueous photoreactive coating material (FIG. 1C) suitable for the preparation of homogenous and mechanically stable composite thin films (FIG. 10B), first 0.16 g P25 TiO₂ and 0.04 g ZnO was added to 996.8 mL of water. Next, 2.73 g 30% aqueous poly(MMA-MAA) latex particles dispersion (Example 1) was also added to the photocatalyst dispersion and the pH was set to >9, preferably 11 by the addition of NaOH. The obtained dispersion was sonicated and, if necessary, the pH was set again for >9, preferably 11.

### Example 3: Synthesis of Photoreactive Coating Material Consists of TiO₂, and Anionic Polyacrylate Binder

0.2 g P25 TiO₂ was added to 996.8 mL of water. Next, 2.73 g 30% aqueous poly(MMA-MAA) latex particles dispersion (Example 1) was added to the photocatalyst dispersion and the pH was set to >9, preferably 11 by the addition of NaOH. The obtained dispersion was sonicated and, if necessary, the pH was set again for >9, preferably 11.

### Example 4: Synthesis of Photoreactive Coating Material Consists of TiO₂, and Anionic Polyacrylate Binder

0.2 g ZnO was added to 996.8 mL of water. Next, 2.73 g 30% aqueous poly(MMA-MAA) latex particles dispersion (Example 1) was added to the photocatalyst dispersion and the pH was set to >9, preferably 11 by the addition of NaOH. The obtained dispersion was sonicated and, if necessary, the pH was set again for >9, preferably 11.

### Example 5: Synthesis of Photoreactive Coating Material Consists of TiO₂, ZnO and Anionic Polyacrylate Binder

Beside the anionic polyacrylate binder describe in Example 1 other negatively charged synthetic- or natural polyanions and their derivatives are also suitable for the preparation of photoreactive coating material such us polyacrylic acid, sodium-polyacrylate, anionic polyacrylamide, sodium-poly(styrene sulfonate), alginate, carboxymethyl cellulose, etc. During the synthesis of the aqueous photoreactive coating material suitable for the preparation of homogenous and mechanically stable composite thin films, first 0.16 g P25 TiO₂ and 0.04 g ZnO was added to 996.8 mL of water. Next, negatively charged synthetic- or natural polyanions listed above was also added to the photocatalyst dispersion in an amount that the photocatalyst/polymer mass ratio will be from 0.2/0.8 to 0.8/0.2 and the pH was set to 11 by the addition of NaOH. The obtained dispersion was sonicated and, if necessary, the pH was set again for 11.

### Example 6: Preparation of Photocatalyst Composite Thin Films

The hybrid layers consist of photocatalysts particles and polyacrylate binder was prepared by applying the spray-coating technique on the substrate surface. During the preparation process, the aqueous suspension obtained in Example 2-6 was evenly sprayed on the substrate surfaces (˜1 L/15 m²) from a distance of 15-30 cm using a R180 type Airbrush spray gun at an operating pressure of 3 bar.

### Example 7: Preparation of Large Surface are Photocatalyst Composite Thin Films

During the surface coating process, the aqueous suspension obtained in Example 2-6 was evenly sprayed on the substrate surfaces (˜1 L/15 m²) from a distance of 15-30 cm using a Graco HVLP type air assisted spray gun at an operating pressure of 1-2 bar.

Having thus described the invention, what is claimed as new and desired to be secured by Letters Patent is:

1. A surface charge stabilized aqueous dispersion suitable for the preparation of photocatalytically active antimicrobial coating comprising:
a) one or more variety of semiconductor photocatalyst particles and
b) and at least one variety of polymeric binder material.

2. The aqueous photocatalyst dispersion as claimed in claim 1, wherein the semiconductor photocatalyst particles are TiO₂, ZnO or a combination thereof and the pH of the aqueous dispersion is higher than the point of zero charge (PZC) of the particles.

3. The aqueous photocatalyst dispersion as claimed in claim 1, wherein the primary particle size of the photocatalyst is below 500 nm

4. The aqueous photocatalyst dispersion as claimed in claim 1, wherein polymeric binder materials are anionic polyelectrolyte latex particles, linear macromolecules or a combination thereof.

5. The polymeric binder materials as claimed in claim 4, wherein anionic macromolecules comprise ˜100 nm latex particles.

6. The aqueous photocatalyst dispersion as claimed in claim 1, wherein the total concentration of semiconductor photocatalyst particles and polymer binder material is below 2.5% and the pH of the dispersion is between 8 and 12.

7. A process for producing the aqueous photocatalyst dispersion as claimed in claim 1, wherein the following steps are taken:
i) dispersing 0.01-0.5% of photocatalyst particles in distilled water then adding 0.04-2% of poly(MMA-MAA) latex particles dispersion;
ii) optionally stirring the dispersion obtained in step i); and,
ii) setting the pH of the dispersion obtained to 8-12, preferably 8-11.

8. The aqueous photocatalyst dispersion as claimed in claim 1, wherein the dispersion is suitable for the preparation of transparent and wear resistant antimicrobial coating with evenly distributed photocatalyst particles.

9. The coating as claimed in claim 8, in the form of a thin film deposited by spray-coating the aqueous dispersion on a substrate (˜1 L/15 m²) from a distance of 15-30 cm using a spray gun at an operating pressure of 3-5 bar.
